(19) United States
(12) Patent Application Publication
(10) Pub. No.: US 2022/0406120 A1
(43) Pub. Date: Dec. 22, 2022

(54) METHOD AND APPARATUS FOR IMAGE PROCESSING, ELECTRONIC DEVICE, AND COMPUTER STORAGE MEDIUM

(71) Applicant: SENSETIME INTERNATIONAL PTE. LTD., Singapore (SG)

(72) Inventors: Zhiyang Guo, Singapore (SG); Xinxin Wang, Singapore (SG)

(21) Appl. No.: 17/364,393

(22) Filed: Jun. 30, 2021

Related U.S. Application Data
(63) Continuation of application No. PCT/IB2021/055663, filed on Jun. 25, 2021.

(30) Foreign Application Priority Data
Jun. 18, 2021 (SG) 10202106587X

(51) Int. Cl. G07F 17/32; G06K 9/00; G06T 7/70

(52) U.S. Cl. CPC G07F 17/322; G06K 9/00744; G06T 7/70

(57) ABSTRACT

A method and apparatus for image processing, an electronic device, and a computer storage medium are provided. The method includes that: at least one frame of game platform image is acquired; the at least one frame of game platform image is detected to obtain a detection result of each of the at least one frame of game platform image, the detection result at least including position information of at least one money substitute; and under a condition that the position information of the at least one money substitute meets a preset alerting condition, first alert information is generated.

### CROSS-REFERENCE TO RELATED APPLICATIONS

This is a continuation application of International Patent Application No. PCT/IB2021/055663, filed on 25 Jun. 2021, which claims priority to Singapore Patent Application No. 10202106587X, filed to the Singapore Patent Office on 18 Jun. 2021 and entitled “METHOD AND APPARATUS FOR IMAGE PROCESSING, ELECTRONIC DEVICE, AND COMPUTER STORAGE MEDIUM”. The disclosures of International Patent Application No. PCT/IB2021/055663 and Singapore Patent Application No. 10202106587X are incorporated herein by reference in their entireties.

### BACKGROUND

In a game platform, money substitutes may be placed at any position by a game player or a game controller. However, there are certain constraints on placement positions of money substitutes in some games. For example, in a game scene where a placement position of money substitutes represents that a player selects one of multiple optional game participants, whether the placement position of the money substitutes meets a requirement is required to be detected. Whether the position of the money substitutes meets the requirement is usually determined by observation with eyes, which increases the labor cost and the time cost to a certain extent.

### SUMMARY

The disclosure relates to a computer vision processing technology, and relates, but not limited, to a method and apparatus for image processing, an electronic device, and a computer storage medium.

Embodiments of the disclosure are intended to provide a method and apparatus for image processing, an electronic device, and a computer storage medium, which may solve the problem of relatively high labor cost and time cost in the related art.

The embodiments of the disclosure provide a method for image processing, which may include the following operations.

At least one frame of game platform image is acquired.

The at least one frame of game platform image is detected to obtain a detection result of each of the at least one frame of game platform image, the detection result at least including position information of at least one money substitute.

Under the condition that the position information of the at least one money substitute meets a preset alerting condition, first alert information is generated.

The embodiments of the disclosure also provide an apparatus for image processing, which may include an acquisition module, a first processing module, and a second processing module.

The acquisition module may be configured to acquire at least one frame of game platform image.

The first processing module may be configured to detect the at least one frame of game platform image to obtain a detection result of each of the at least one frame of game platform image, the detection result at least including position information of at least one money substitute.

The second processing module may be configured to, under the condition that the position information of the at least one money substitute meets a preset alerting condition, generate first alert information.

The embodiments of the disclosure also provide an electronic device, which may include a processor and a memory configured to store computer programs capable of running in the processor.

The processor may be configured to run the computer programs to execute any one of the above methods for image processing.

The embodiments of the disclosure also provide a computer storage medium having stored therein computer programs which are executed by a processor to implement any one of the above methods for image processing.

The embodiments of the disclosure also provide a computer program product comprising computer-executable instructions. When the computer-executable instructions run in a processor of a device, the processor implement any one of the above methods for image processing.

It is to be understood that the above general description and the following detailed description are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of a method for image processing according to embodiments of the disclosure.

FIG. 2A is a schematic reference diagram of a game platform image according to embodiments of the disclosure.

FIG. 2B is a division diagram of money substitute regions obtained based on FIG. 2A.

FIG. 2C is a schematic diagram of a positional relationship between money substitutes and money substitute regions according to an embodiment of the disclosure.

FIG. 3 is a composition structure diagram of an apparatus for image processing according to embodiments of the disclosure.

FIG. 4 is a composition structure diagram of an electronic device according to embodiments of the disclosure.

### DETAILED DESCRIPTION

According to the method and apparatus for image processing, electronic device, and computer storage medium disclosed in the embodiments of the disclosure, the at least one frame of game platform image is acquired, the at least one frame of game platform image is detected to obtain the detection result of each of the at least one frame of game platform image, the detection result at least including the position information of at least one money substitute, and under the condition that the position information of the at least one money substitute meets the preset alerting condition, the first alert information is generated.

It can be seen that, in the embodiments of the disclosure, the game platform image may be detected to determine the position information of the at least one money substitute to further determine whether the position of the at least one money substitute meets the requirement. Compared with a solution of determining whether the position of the at least one money substitute meets the requirement by observation with eyes in the related art, the embodiments have the advantages that the labor cost is reduced, and whether the position of the at least one money substitute meets the requirement may be determined faster.

The disclosure will further be described below in combination with the drawings and the embodiments in detail. It is to be understood that the embodiments provided herein are only adopted to explain the disclosure and not intended to limit the disclosure. In addition, the embodiments provided below are not all embodiments implementing the disclosure but part of embodiments implementing the disclosure, and the technical solutions recorded in the embodiments of the disclosure may be freely combined for implementation without conflicts.

It is to be noted that, in the embodiments of the disclosure, terms “include” and “contain” or any other variant thereof is intended to cover nonexclusive inclusions herein, so that method or device including a series of elements not only includes those clearly recorded elements but also includes other elements which are not clearly listed or further includes intrinsic elements for implementing the method or the device. Under the condition of no more limitations, an element defined by a statement “including a/an” does not exclude existence of another related element in a method or device including the element (for example, step in the method or a unit in the device, the unit may be, for example, part of a circuit, part of a processor and part of a program or software).

For example, a method for image processing provided in the embodiments of the disclosure includes a series of operations, but the method for image processing provided in the embodiments of the disclosure is not limited to the recorded operations. Similarly, an apparatus for image processing provided in the embodiments of the disclosure includes a series of modules, but the apparatus provided in the embodiments of the disclosure is not limited to include the clearly recorded modules and may further include one or more modules required to be configured when related information is acquired or processing is performed based on information.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

The embodiments of the disclosure may be applied to an edge computing device in a game scene, and may be operated together with numerous other universal or dedicated computing system environments or configurations. Here, the edge computing device may be a thin client, a thick client, a handheld or laptop device, a microprocessor-based system, a set-top box, a programmable consumer electronic product, a network personal computer, a minicomputer system, etc.

The edge computing device may include a program module that executes an instruction. Under a normal condition, the program module may include a routine, a program, a target program, a component, a logic, a data structure and the like, and they execute specific tasks or implement specific abstract data types. The computer system/server may be implemented in a distributed cloud computing environment, and in the distributed cloud computing environment, tasks are executed by a remote processing device connected through a communication network. In the distributed cloud computing environment, the program module may be in a storage medium of a local or remote computer system including a storage device.

In the related art, in a game scene, position information of a money substitute is required to be used for calculation of a game result, alerting detection of the money substitute (for example, a minimum denomination of the money substitute, and a maximum denomination of the money substitute), etc. Alerting detection related to the money substitute may be executed accurately only when accurate position information of the money substitute is obtained. However, in the related art, whether a position of the money substitute meets a requirement is usually determined by observation with eyes, which increases the labor cost and the time cost to a certain extent.

For the foregoing technical problem, there is proposed in some embodiments of the disclosure a technical solution for image processing, which may be applied to a game scene.

An application scene of the embodiments of the disclosure will be exemplarily described below.

In the game scene, a running state of each game may be monitored through a computer vision processing technology. Here, running of each game may be related to at least one money substitute.

In some embodiments, the game in the game scene may be poker or other games on a game platform. No limits are made thereto in the embodiments of the disclosure.

In the embodiments, computer vision, as a science researching how to make machines “see”, refers to a technology of identifying, tracking, and measuring targets using video cameras and computers instead of human eyes, and further performing image processing. In a game process, three cameras may be used to detect what happens on the game platform for further analysis. The game platform may be a physical tabletop platform or another physical platform.

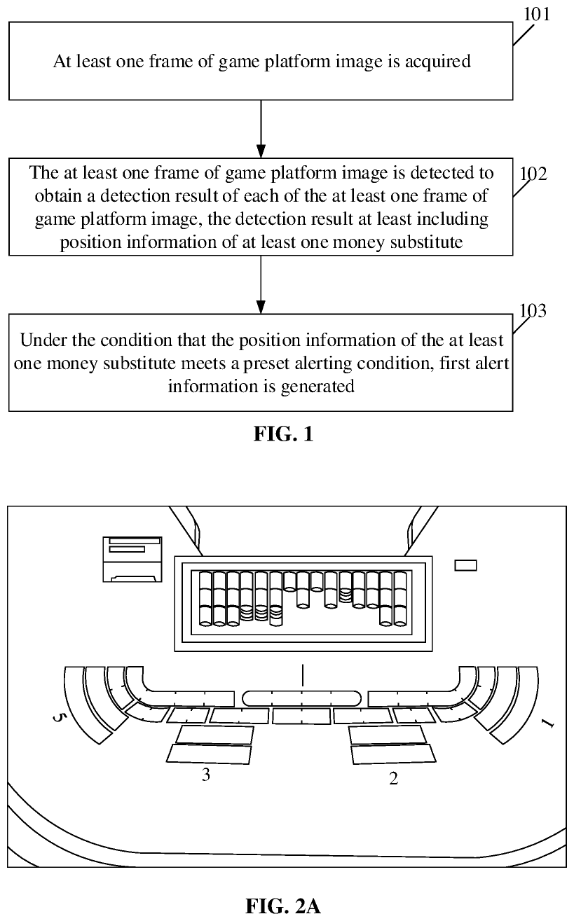

FIG. 1 is a flowchart of an image processing method according to an embodiment of the disclosure. As shown in FIG. 1, the flow may include the following operations.

In 101, at least one frame of game platform image is acquired.

In the embodiments of the disclosure, a game platform may be shot using at least one camera to obtain video data or image data, and then the at least one frame of game platform image is acquired from the video data or the image data. In some embodiments, the camera that shoots the game platform may be a camera that is located over the game platform and configured to shoot a plan-view image of the game platform, or may be a camera for shooting the game platform from another view. Correspondingly, each frame of game platform image may be the plan-view image or a game platform image of the other view. In some other embodiments, each frame of game platform image may also be an image obtained by performing fusion processing on the plan-view image and the game platform image of the other view.

In 102, the at least one frame of game platform image is detected to obtain a detection result of each frame of game platform image in the at least one frame of game platform image, the detection result at least including position information of at least one money substitute.

In the embodiments of the disclosure, after each frame of game platform image is obtained, each frame of game platform image may be detected through a computer vision processing technology to obtain the detection result of each frame of game platform image. In some embodiments, each frame of game platform image may be detected to obtain at least one target object in each frame of game platform image. The target object at least includes money substitutes. Exemplarily, the target object may further include marker of the game platform, human body, and playing cards. The human body in the target object may include the whole human body, or may include part of the human body such as a hand and the face. The playing cards in the target object may be playing cards of a type such as spade, heart, diamond, and club. After the at least one target object in each frame of image is obtained, a corresponding detection result may be determined based on the at least one target object in each frame of image. Here, the detection result may include position information of the at least one target object.

In some embodiments, the detection result may further include at least one of a denomination, a type, an amount, or ownership information.

In the embodiments of the disclosure, the number of the at least one money substitute is the number of money substitutes in a group of money substitutes. A group of money substitutes may be one money substitute, or may include multiple money substitutes. Here, the multiple money substitutes may form a pile of money substitutes. A right ownership of the money substitute is configured to represent information of an owner of the money substitute. The information of the owner of the money substitute may include Identity document (ID) information of the owner of the money substitute.

In some embodiments, a money substitute image may be analyzed to determine the information such as the denomination of the at least one money substitute, the type of the at least one money substitute, and the number of the at least one money substitute. The ownership information of the at least one money substitute may be determined according to an image of the human body in contact with the at least one money substitute.

In 103, under the condition that the position information of the at least one money substitute meets a preset alerting condition, first alert information is generated.

In some embodiments, the preset alerting condition may be information predetermined according to practical needs. In some embodiments, an edge computing device may receive a predetermined configuration file. The configuration file may include the preset alerting condition, so that the edge computing device may determine whether the position information of the at least one money substitute meets the preset alerting condition according to the configuration file.

In some embodiments, the first alert information may be displayed text information, audio alert information or alert information of other types. No limits are made thereto in the embodiments of the disclosure.

In some embodiments, the at least one frame of game platform image sent by an image collection device may be received by using the edge computing device. The at least one frame of game platform image is at least one image collected by the image collection device. The image collection device may include at least one above-recorded camera.

Correspondingly, the at least one frame of game platform image may be detected by using the edge computing device to obtain the detection result of each frame of game platform image in the at least one frame of game platform image. Under the condition that the position information of the at least one money substitute meets the preset alerting condition, the first alert information is generated by using the edge computing device.

In practical applications, 101 to 103 may be implemented by using a processor in the edge computing device. The processor may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing unit (CPU), a controller, a microcontroller, or a microprocessor.

It can be seen that, in the embodiments of the disclosure, the game platform image may be detected to determine the position information of the at least one money substitute to further determine whether the position of the at least one money substitute meets the requirement. Compared with a solution of determining whether the position of the at least one money substitute meets the requirement by observation with eyes in the related art, the embodiments have the advantages that the labor cost is reduced, and whether the position of the at least one money substitute meets the requirement may be determined faster.

Furthermore, besides a poker scene, the embodiments of the disclosure may be applied to various scenes where money substitutes are used. Therefore, in various scenes where money substitutes are used, whether the position of the money substitutes meets a requirement may be determined relatively fast, and the characteristic of easiness for implementation is achieved.

In some embodiments, the at least one frame of game platform image includes N frames of game platform images, N being an integer greater than 1.

Correspondingly, the operation that the at least one frame of game platform image is detected to obtain the detection result of each frame of game platform image in the at least one frame of game platform image may include the following operation. Under the condition of determining N frames of game platform images each time using a sliding window, a detection result of each of the N frames of game platform images is determined according to detection results of the N frames of game platform images in the sliding window.

In some embodiments, a size of the sliding window may be preset through the configuration file, namely a value of N may be configured through the configuration file. After the detection result of each frame of game platform images is obtained, the detection result of each frame of game platform images may be sequentially stored in the sliding window according to a time sequence. In some embodiments, the detection result of each frame of game platform images is in a message queue. The detection result of each frame in the message queue may be consumed, and the consumed detection result of each frame of images may be sequentially stored in the sliding window. Under the condition that the number of the detection results in the sliding window reaches N, if a detection result of a new frame of image in the message queue is required to be consumed, the sliding window moves so that a target frame image is pushed out, and a detection result of the target frame image is obtained. The target frame image represents one frame of image that is changed from a state of being in the sliding window to a state of being out of the sliding window after the sliding window moves. In the embodiments of the disclosure, the target frame image is any one frame of image in the N frames of game platform images when the sliding window does not move.

It can be seen that, in the embodiments of the disclosure, money substitute information in each frame of game platform images may be determined by using detection results of multiple frames of game platform images in the sliding window. Since the detection results of the multiple frames of game platform images include more, and more accurate money substitute information, the money substitute information in each frame of game platform images may be obtained relatively accurately in the embodiments of the disclosure, and the detection accuracy of the at least one money substitute may be improved effectively.

In some embodiments, the N frames of game platform images may be N discontinuous frames of images, or may be N continuous frames of images. Under the condition that the N frames of game platform images are N continuous frames of images, the money substitute information in the target frame image may be obtained more accurately in the embodiments of the disclosure based on the money substitute information in the N continuous frames of images.

In some embodiments, the target frame image is an earliest frame of image in the N frames of game platform images. In such case, in the embodiments of the disclosure, the money substitute information in the earliest frame of image in the N frames of images may be obtained, thereby timely acquiring accurate money substitute information.

In an implementation mode, if the value of N is 5, detection results of a first frame of image to a fifth frame of image may be sequentially stored in the sliding window. Under the condition that the number of the detection results in the sliding window reaches 5, if a detection result of a sixth frame of image is required to be stored in the sliding window, a right edge of the sliding window moves rightwards to push the detection result of the first frame of image out of the sliding window, and in such case, the first frame of image is the target frame image. Under the condition that the detection result of the first frame of image is pushed out of the sliding window, data in the sliding window is the detection results of a second frame of image to the sixth frame of image. Afterwards, if a detection result of a seventh frame of image is required to be stored in the sliding window, the right edge of the sliding window moves rightwards to push the detection result of the second frame of image out of the sliding window, and in such case, the second frame of image is the target frame image. Under the condition that the detection result of the second frame of image is pushed out of the sliding window, data in the sliding window is the detection results of a third frame of image to the seventh frame of image. In this manner, multiple target frame images may be sequentially determined through a sliding mechanism of the sliding window.

In some embodiments, the operation that the detection result of each the N frames of game platform images is determined according to the detection results of the N frames of game platform images in the sliding window may include the following operations.

Attribute information of the same group of money substitutes in the detection results of the N frames of game platform images is determined by target tracking. The attribute information corresponding to a maximum occurrence frequency is determined in an election manner from the attribute information of the same group of money substitutes. A detection result in a target frame image is determined to be the attribute information corresponding to the maximum occurrence frequency.

In the embodiments of the disclosure, the attribute information of the money substitute includes the position of the money substitute. The attribute information of the money substitute may further include at least one of the denomination, the type, the amount, or the ownership information.

In the embodiments of the disclosure, the same group of money substitutes includes at least one money substitute. For the detection results of the N frames of game platform images, the attribute information of the same group of money substitutes in the detection results of the N frames of game platform images may be determined by a target tracking method. In some embodiments, a track ID of a group of money substitutes in the target frame image is determined by a target detection method, and then target tracking is performed on the detection results of the N frames of game platform images in the sliding window based on the track ID of the group of money substitutes in the target frame image to determine the attribute information of the same group of money substitutes in the detection results of the N frames of game platform images.

In some embodiments, under the condition that the attribute information includes the denomination of the money substitute, denomination data corresponding to a maximum occurrence frequency may be determined in the election manner from the attribute information of the same group of money substitutes. For example, if the value of N is 5, the data in the sliding window is the detection results of the first frame of image to the fifth frame of image, the target frame image is the first frame of image, and denominations of each group of money substitutes in the first frame of image to the fifth frame of image may be recognized according to the detection results of the first frame of image and the fifth frame of image. Under the condition that the denominations of a group of money substitutes with the same track ID in the first frame of image, the second frame of image, the third frame of image, a fourth frame of image, and the fifth frame image are recognized to be 200, 200, 300, 300, and 300 respectively, it may be determined in the selection manner that the denomination corresponding to the maximum occurrence frequency is 300. In such case, it may be determined that the denomination of the corresponding group of money substitutes in the first frame of image is inaccurate, and the denomination of the corresponding part of money substitutes in the first frame of image may be updated to 300. Under the condition that denominations of a group of money substitutes with the same track ID in the first frame of image, the second frame of image, the third frame of image, the fourth frame of image, and the fifth frame of image are recognized to be 400, 400, 400, 400, and 300 respectively, it may be determined in the election manner that the denomination corresponding to the maximum occurrence frequency is 400. In such case, it may be determined that the denomination of the corresponding group of money substitutes in the first frame of image is accurate, and the denomination of the corresponding group of money substitutes in the first frame of image may be kept to 400.

In some embodiments, under the condition that the attribute information includes the number of the money substitute, information of the number of money substitutes corresponding to a maximum occurrence frequency may be determined in the election manner from the attribute information of the same group of money substitutes. For example, if the value of N is 5, the data in the sliding window is the detection results of the first frame of image to the fifth frame of image, the target frame image is the first frame of image, and the number of each group of money substitutes in the first frame of image to the fifth frame of image may be recognized according to the detection results of the first frame of image and the fifth frame of image. Under the condition that the numbers of a group of money substitutes with the same track ID in the first frame of image, the second frame of image, the third frame of image, a fourth frame of image, and the fifth frame image are recognized to be 3, 3, 4, 4, and 4 respectively, it may be determined in the election manner that the number of money substitutes corresponding to the maximum occurrence frequency is 4. In such case, it may be determined that the number of the corresponding group of money substitutes in the first frame of image is inaccurate, and the number of the corresponding group of money substitutes in the first frame of image may be updated to 4. Under the condition that the numbers of a group of money substitutes with the same track ID in the first frame of image, the second frame of image, the third frame of image, the fourth frame of image, and the fifth frame of image are recognized to be 4, 4, 4, 4, and 3 respectively, it may be determined by election that the number of money substitutes corresponding to the maximum occurrence frequency is 4. In such case, it may be determined that the number of the corresponding group of money substitutes in the first frame of image is accurate, and the number of the corresponding group of money substitutes in the first frame of image may be kept to 4.

In some embodiments, the operation that the detection result of each of the N frames of game platform images is determined according to the detection results of the N frames of game platform images in the sliding window may include the following operations.

Attribute information of each group of money substitutes of which a confidence is more than or equal to a confidence threshold in the detection results of the N frames of game platform images is determined, and the attribute information of the same group of money substitutes is determined by target tracking from the attribute information of each group of money substitutes of which the confidence is more than or equal to the confidence threshold.

The attribute information corresponding to the maximum occurrence frequency is determined in the election manner from the attribute information of the same group of money substitutes, and the detection result in the target frame image is determined to be the attribute information corresponding to the maximum occurrence frequency.

Here, the confidence threshold may be preset according to a practical application requirement. Exemplarily, the confidence threshold may be 0.9 or 1. An implementation manner for determining attribute data corresponding to the maximum occurrence frequency in the election manner has been described in the above contents, and will not be elaborated herein.

It can be understood that, due to the existence of factors such as the influence of brightness of site light, occlusion between money substitutes, and occlusion of the money substitutes as well as movement of the money substitutes caused by a player in a game process, money substitute information in the target frame image may be inaccurate. In the embodiments of the disclosure, the attribute information of the money substitute information corresponding to the maximum occurrence frequency is elected from the attribute information of the money substitute in the multiple frames of game platform images in an election manner, so that the accuracy of the attribute information of the money substitute in the target frame image may be improved to a certain extent.

In some embodiments, a hand detection box and money substitute detection box in the target frame image may be determined. Under the condition that the hand detection box and the money substitute detection box do not overlap, whether the position information of the at least one money substitute in the target frame image meets the preset alerting condition is determined.

In the embodiments of the disclosure, hand detection and money substitute detection may be performed on the target frame image to determine the hand detection box and money substitute detection box in the target frame image. In some embodiments, the target frame image may be input to a first neural network for hand detection and a second neural network for money substitute detection respectively, and the target frame image is processed using the first neural network and the second neural network to obtain the hand detection box and money substitute detection box in the target frame image. Network structures of the first neural network and the second neural network are not limited in the embodiments of the disclosure. For example, each of the first neural network and the second neural network may be a Single Shot MultiBox Detector (SSD), You Only Look Once, a Faster Region-Convolutional Neural Network (Faster RCNN), or another deep-learning-based neural network.

In the embodiments of the disclosure, an overlapping degree of the hand detection box and money substitute detection box in the target frame image may be calculated according to the hand detection box and money substitute detection box in the target frame image. Under the condition that the overlapping degree is greater than 0, it may be determined that the hand detection box and money substitute detection box in the target frame image are overlapped. Under the condition that the overlapping degree is equal to 0, it may be determined that the hand detection box and money substitute detection box in the target frame image are not overlapped.

In some embodiments, under the condition that the hand detection box and the money substitute detection box overlap, the money substitute information corresponding to the money substitute detection box cannot be acquired reliably from the detection result of the target frame image, namely whether the preset alerting condition is met is not determined according to the position information of the money substitute corresponding to the money substitute detection box.

In an implementation mode, under the condition that the hand detection box and the money substitute detection box do not overlap, it may be determined that the corresponding money substitute in the target frame image is a stably recognized money substitute. In such case, whether the position information of the money substitute in the target frame image meets the preset alerting condition may be determined.

In some embodiments, a target region where the at least one money substitute is located in may be determined according to the position information of the at least one money substitute and the predetermined game platform image region division information. The game platform image region division information includes position information of multiple target regions obtained by performing region division on the game platform. Whether the position information of the at least one money substitute meets the preset alerting condition is determined according to the target region where the at least one money substitute is located in.

In some embodiments, the at least one money substitute in each frame of game platform image may be recognized, and a mapping relationship is established between the recognized at least one money substitute and the predetermined game platform image region division information to obtain the target region where the at least one money substitute is located in.

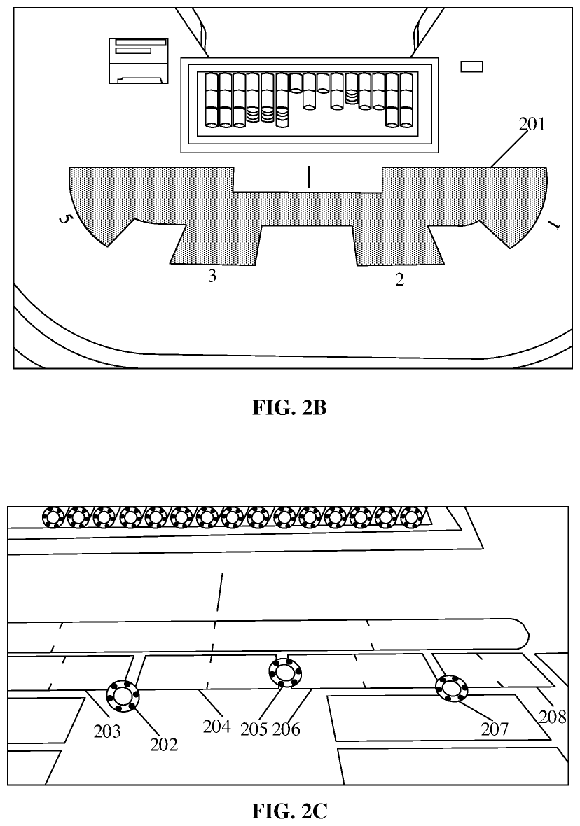

Exemplarily, FIG. 2A is a schematic reference diagram of a game platform image according to embodiments of the disclosure. FIG. 2B is a division diagram of money substitute regions obtained based on FIG. 2A. It can be seen that FIG. 2B shows a first money substitute region 201.

Referring to FIG. 2B, under the condition that the target object is a group of money substitutes, in some embodiments, if the group of money substitutes is wholly in the money substitute region 201 in FIG. 2B, it may be determined that the position of the money substitutes meets the requirement.

It can be seen that, in the embodiments of the disclosure, whether the position information of the money substitutes meets the preset alerting condition may be determined according to the target region where the money substitutes are located in, and the target region where the money substitutes are located in is usually related to a constraint on a practical position of the money substitutes, so that accurate determination about whether the position information of the money substitutes meets the preset alerting condition is facilitated to a certain extent.

In some embodiments, under the condition of determining that the at least one money substitute is located in at least two target regions, it is determined that the position information of the at least one money substitute meets the preset alerting condition.

It can be seen that, in the embodiments of the disclosure, if a region, where the at least one money substitute is located in, in the game platform includes multiple target regions, it may be determined that the position of the at least one money substitute does not meet the requirement. In such case, the first alert information is generated, which is facilitated to timely prompt a user to relocate the at least one money substitute.

In some embodiments, under the condition of determining that the at least one money substitute is located in at least two predetermined target regions, it is determined that the position information of the at least one money substitute meets the preset alerting condition.

In the embodiments of the disclosure, region division is performed on the game platform to obtain the multiple target regions, and the multiple target regions may be divided into predetermined target regions and non-predetermined target regions. The predetermined target region includes a region, where money substitute is allowed to be located in, in the multiple target regions. The non-predetermined target region includes a region, where money substitute is not allowed to be located in, in the multiple target regions.

In the embodiments of the disclosure, different predetermined target regions may be set according to different stages of a game, so that the corresponding predetermined target region may be determined according to the game stage that the game is in at a present moment.

In some embodiments, the at least one money substitute should be located in one predetermined target region. If the region, where the at least one money substitute is located in, in the game platform includes multiple adjacent predetermined target regions, it may be determined that the position of the at least one money substitute does not meet the requirement.

Referring to FIG. 2C, a first money substitute 202 is located between a second money substitute region 203 and a third money substitute region 204. Under the condition that the second money substitute region 203 and the third money substitute region 204 are predetermined target regions, a region, where the first money substitute 202 is located in, in the game platform includes multiple adjacent predetermined target regions. In such case, a position of the first money substitute 202 does not meet a requirement, and first alert information may be generated to prompt the user to relocate the first money substitute 202.

A second money substitute 205 is located between the third money substitute region 204 and a fourth money substitute region 206. Under the condition that the third money substitute region 204 and the fourth money substitute region 206 are predetermined target regions, a region, where the second money substitute 205 is located in, in the game platform includes multiple adjacent predetermined target regions. In such case, a position of the second money substitute 205 does not meet a requirement, and first alert information may be generated to prompt the user to relocate the second money substitute 205.

A third money substitute 207 is located between the fourth money substitute region 206 and a fifth money substitute region 208. Under the condition that the fourth money substitute region 206 and the fifth money substitute region 208 are predetermined target regions, a region, where the third money substitute 207 is located in, in the game platform includes multiple adjacent predetermined target regions. In such case, a position of the third money substitute 207 does not meet a requirement, and first alert information may be generated to prompt the user to relocate the third money substitute 207.

It can be seen that, in the embodiments of the disclosure, if the region, where the money substitute is located in, in the game platform includes multiple predetermined target regions, it may be determined that the position of the money substitute does not meet the requirement. In such case, the first alert information is generated to help to timely prompt the user to relocate the money substitute.

In some embodiments, the at least one money substitute may be detected to obtain a detection box for the at least one money substitute in the game platform image, and the detection box for the at least one money substitute is used to represent the position information of the at least one money substitute. After the detection box for the at least one money substitute in the game platform image is obtained, the detection box for the at least one money substitute may be meshed, a preset number of feature points of the at least one money substitute are extracted from each divided mesh, and the target region where the at least one money substitute is located in is determined according to a target region where each of the multiple feature points extracted from each divided mesh is located in.

Exemplarily, for each target region that overlaps the money substitute, the number of the feature points in the corresponding target region in all the extracted feature points is counted. For example, the detection box for the at least one money substitute is equally divided into 10 meshes, and 10 feature points of the at least one money substitute are extracted from each mesh. For each target region that overlaps the at least one money substitute, the number of the feature points in the target region in the totally 100 extracted feature points is counted. An overlapping area of the at least one money substitute and each target region is further determined according to the counted number or ratio of the feature points in each target region. Furthermore, under the condition that the overlapping area corresponding to a target region reaches a preset area threshold or a preset area ratio, it is determined that the at least one money substitute is located in the target region.

It can be seen that, in the embodiments of the disclosure, the detection box for the money substitute may be meshed to facilitate accurate determination of the target region where the money substitute is located.

In some embodiments, an area of the part of the at least one money substitute located within each predetermined target region in the game platform is determined according to the position information of the at least one money substitute and the predetermined game platform image region division information. In response to the area of the part of the at least one money substitute located within each predetermined target region in the game platform being less than an area threshold, it is determined that the position information of the at least one money substitute meets the preset alerting condition.

In some embodiments, the area threshold may be a numerical value in the predetermined configuration file, or may be a value determined according to a total area of the at least one money substitute. The area threshold may be a product of the total area of the at least one money substitute and a set ratio. For example, the set ratio may be a positive number less than 20%.

It is to be understood that, if the area of the part of the at least one money substitute located within each predetermined target region in the game platform is less than the area threshold, it indicates that part of the at least one money substitute is located in another predetermined target region or a non-predetermined target region, and it may be determined that the position of the at least one money substitute does not meet the requirement.

In some embodiments, an area of the part of the at least one money substitute located within each target region in the game platform may be determined according to the number of divided meshes in the target region and an area of each mesh.

In some embodiments, the detection box for the at least one money substitute may be meshed equally or unequally. Exemplarily, the detection box for the at least one money substitute may be transversely and longitudinally divided into 10*10 meshes equally according to coordinates of an angular points (for example, including coordinates of a left upper corner and a right lower corner) of the detection box for at least one the money substitute, and then an area of meshes located within the predetermined target region may be determined according to regional positions of the 100 meshes in the game platform, namely an area of the part of the at least one money substitute located within the predetermined target region in the game platform is determined.

It can be seen that, in the embodiments of the disclosure, if the area of the part of the at least one money substitute located within each predetermined target region in the game platform is less than the area threshold, it may usually be determined that the position of the at least one money substitute does not meet the requirement. In such case, the first alert information is generated to help to timely prompt the user to relocate the money substitute.

In some embodiments, the position information of the at least one money substitute includes a position of a center point of the at least one money substitute.

Correspondingly, the method further includes the following operations. A target region where the center point is located in is determined according to the position information of the at least one money substitute and the predetermined game platform image region division information. In response to that the center point is located in a non-predetermined target region, it is determined that the position information of the at least one money substitute meets the preset alerting condition.

In some embodiments, a position of a center point of the detection box for the at least one money substitute may be determined as the position of the center point of the at least one money substitute.

In some embodiments, the corresponding predetermined target region may be determined according to the game stage that the game is in at the present moment, and the non-predetermined target region is further determined.

It can be seen that, in the embodiments of the disclosure, if the position of the center point of the at least one money substitute is in the non-predetermined target region of the game platform, it may be determined that the position of the at least one money substitute does not meet the requirement. In such case, the first alert information is generated to help to timely prompt the user to relocate the money substitute.

In some embodiments, the detection result further includes attribute information of the at least one money substitute. The method may further include the following operations. Under the condition that the position information of the at least one money substitute does not meet the preset alerting condition, whether the attribute information of the at least one money substitute meets an attribute constraint corresponding to the target region where the at least one money substitute is located in is determined according to the game platform image.

Under the condition that the attribute information of the at least one money substitute does not meet the attribute constraint corresponding to the target region where the money substitute is located in, second alert information is generated.

In some embodiments, attribute constraints corresponding to all target regions are stored in the predetermined configuration file. In such case, the edge computing device may acquire the configuration file to acquire the attribute constraint corresponding to each target region. Therefore, under the condition that the position information of the at least one money substitute does not meet the preset alerting condition, whether the attribute information of the at least one money substitute meets the attribute constraint corresponding to the target region where the at least one money substitute is located in may be judged.

In some embodiments, the attribute constraint corresponding to the target region where the at least one money substitute is located in may be the type of the money substitute with which betting is allowed in the target region, the denomination of the money substitute with which betting is allowed in the target region, etc. It is to be noted that the above contents are only exemplary descriptions about the attribute constraint corresponding to the target region and not intended to limit the embodiments of the disclosure.

It is to be noted that, under the condition that the attribute information of the at least one money substitute meets the attribute constraint corresponding to the target region where the at least one money substitute is located in, the game may be played according to a normal game flow.

It can be seen that, in the embodiments of the disclosure, under the condition that the attribute information of the at least one money substitute does not meet the attribute constraint corresponding to the target region where the at least one money substitute is located in, the second alert information may be generated to help to prompt the user to place the at least one money substitute according to the corresponding attribute constraint.

The embodiments of the disclosure will be exemplarily described below in combination with an application scene. In the application scene, the game scene is an intelligent casino scene, the game platform is a gaming table, and the money substitute is a chip.

The intelligent casino scene may be a poker game. Running stages of the poker game may include an idle stage, a betting stage, a gaming stage, a payout stage, and a halt stage. The idle stage represents a stage after the devices, such as an edge computing device, etc., are powered on, and at this stage, no service processing result or alert information may be sent to a casino management system. The betting stage represents a stage of betting before card dealing of the dealer. The payout stage represents a stage that the dealer starts paying out or collecting money after the game is over. If the card dealing operation of the dealer violates a game rule or a regulation of the casino, the halt stage is entered. In the halt stage, objects on and around the gaming table may still be detected and recognized, service processing is performed based on a detection and recognition result, and a service processing result or alert information may be sent to the casino management system.

The player is not allowed to bet in the idle stage, the payout stage, and the halt stage. The player is allowed to bet in the betting stage. The dealer deals cards in the gaming stage. In some examples, the player is allowed to bet in the gaming stage. In some other examples, the player is not allowed to bet in the gaming stage.

Exemplarily, the poker game may be Baccarat or another type of game. In a Baccarat scene, the dealer draws four to six cards from three to eight decks of shuffled cards, and a win-lose result may be obtained according to a rule. The win-lose result may include: the player, the banker, TIE, super six, etc. Gained or paid money of the player and the casino is calculated according to the win-lose result of each round of game, payout ratios in different scenes, and whether to take commissions. There are certain rules for card dealing of the dealer and checking of the player, and if the rules are broken, the monitoring system needs to output warning information.

In the intelligent casino scene, multiple frames of gaming table images may be collected by a camera, and then the collected multiple frames of gaming table images are sent to the edge computing device of the intelligent casino. Each of at least one frame of gaming table image is detected in the edge computing device to obtain a detection result of each frame of gaming table image. The detection result of each frame of gaming table image may include position information of the chip.

The edge computing device may determine whether the position information of the chip meets a preset alerting condition, and under the condition that the position information of the chip meets the preset alerting condition, generate first alert information.

In some embodiments, the edge computing device may further determine whether attribute information of the at least one money substitute meets an attribute constraint corresponding to a target region where the at least one money substitute is located in under the condition that the position information of the chip does not meet the preset alerting condition, and under the condition that the attribute information of the at least one money substitute does not meet the attribute constraint corresponding to the target region where the at least one money substitute is located in, generate second alert information.

In some embodiments, the preset alerting condition and an attribute constraint corresponding to each target region may be set in a configuration file. Exemplarily, if the position information of the chip meets the preset alerting condition, or the attribute information of the at least one money substitute does not meet the attribute constraint corresponding to the target region where the at least one money substitute is located in, it may be determined that betting of the player is invalid. For example, a denomination lower limit specified for each betting region in the game is set in the configuration file. If a betting denomination of the chip in a target region is less than the denomination lower limit specified for the corresponding betting region in the game, it may be determined that the detection result does not meet the attribute constraint corresponding to the target region. It can be seen that the first alert information or the second alert information may be generated to prompt the dealer whether betting of the player with the chip meets a requirement to avoid a dispute with the player during payout and timely prompt the player to regulate a betting position.

In some embodiments, the edge computing device may monitor the configuration file transmitted by the casino management system through message middleware, update the configuration file in real time, and determine whether the position information of the chip meets the preset alerting condition or whether the attribute information of the at least one money substitute meets the attribute constraint corresponding to the target region where the at least one money substitute is located in according to a content of the updated configuration file.

In some embodiments, whether the position information of the chip meets the preset alerting condition or whether the attribute information of the at least one money substitute meets the attribute constraint corresponding to the target region where the at least one money substitute is located in may be determined in the betting stage and the gaming stage. In some embodiments, in the gaming stage, in case of four cards face up and five cards face up, if the chip is in a safe betting region, it indicates that the position information of the chip does not meet the preset alerting condition, and if the chip is not in the safe betting region, it indicates that the position information of the chip meets the preset alerting condition. In some embodiments, in the betting region, if the position information of the chip indicates a betting region except the safe betting region, it indicates that the position information of the chip does not meet the preset alerting condition, and if the position information of the chip indicates the safe betting region or a non-betting region, it indicates that the position information of the chip meets the preset alerting condition.

In some embodiments, under the condition that the chip crosses multiple betting regions, it may be determined that the position information of the chip meets the preset alerting condition. For example, under the condition that the chip is simultaneously in a banker region and a player region, it may be determined that the position information of the chip meets the preset alerting condition.

In some embodiments, if an area of the part of the chip located within a predetermined target region is less than an area threshold, exemplarily, if a region where the chip is located in includes only one predetermined target region (which may include a non-predetermined target region) and an area of the part of the chip located within the predetermined target region is less than the area threshold, it indicates that the position information of the chip meets the preset alerting condition. Exemplarily, the area threshold may be 5% or 10% of a total area of the chip.

In some embodiments, under the condition that the position information of the chip meets the preset alerting condition, the corresponding chip may be filtered, namely payout is not performed for the chip.

In some embodiments, filtered chips may be determined, the filtered chips representing chip of which position information does not meet the preset alerting condition. Then, a minimum betting denomination corresponding to each betting region is read according to the transmitted configuration file, the filtered chips are traversed, a chip denomination for betting in the corresponding betting region is determined according to the betting region corresponding to each filtered chip, the chip denomination for betting in the betting region is compared with the minimum betting denomination corresponding to the betting region, and if the chip denomination for betting in the betting region is smaller than the minimum betting denomination corresponding to the betting region, the second alert information is generated.

It can be understood by those skilled in the art that, in the method of the specific implementation modes, the writing sequence of each operation does not mean a strict execution sequence and is not intended to form any limit to the implementation process and a specific execution sequence of each operation should be determined by functions and probable internal logic thereof.

Based on the method for image processing disclosed in the abovementioned embodiments, the embodiments of the disclosure disclose an apparatus for image processing.

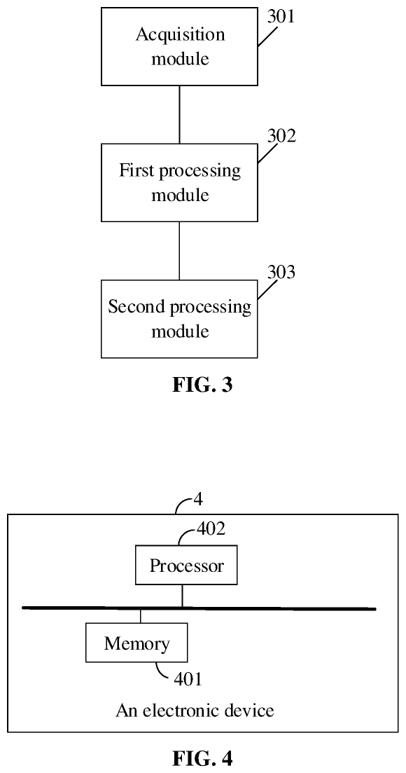

FIG. 3 is a composition structure diagram of an apparatus for image processing according to embodiments of the disclosure. As shown in FIG. 3, the apparatus may include an acquisition module 301, a first processing module 302, and a second processing module 303.

The acquisition module 301 is configured to acquire at least one frame of game platform image.

The first processing module 302 is configured to detect the at least one frame of game platform image to obtain a detection result of each of the at least one frame of game platform image, the detection result at least including position information of at least one money substitute.

The second processing module 303 is configured to, under the condition that the position information of the at least one money substitute meets a preset alerting condition, generate first alert information.

In some embodiments, the second processing module 303 is further configured to: determine a target region where the at least one money substitute is located in according to the position information of the at least one money substitute and predetermined game platform image region division information, the game platform image region division information including position information of multiple target regions obtained by performing region division on a game platform; and determine whether the position information of the at least one money substitute meets the preset alerting condition according to the target region where the at least one money substitute is located in.

In some embodiments, the second processing module 303 is specifically configured to: under the condition of determining that the at least one money substitute is located in at least two target regions, determine that the position information of the at least one money substitute meets the preset alerting condition.

In some embodiments, the second processing module 303 is specifically configured to: under the condition of determining that the at least one money substitute is located in at least two predetermined target regions, determine that the position information of the at least one money substitute meets the preset alerting condition, the predetermined target region including a region, where the at least one money substitute is allowed to be located in, in the target region.

In some embodiments, the second processing module 303 is specifically configured to: determine an area of a part of the at least one money substitute located within each predetermined target region in the game platform according to the position information of the at least one money substitute and the predetermined game platform image region division information, the predetermined target region representing a target region where the at least one money substitute is allowed to be located in; and in response to that the area of a part of the at least one money substitute located within each predetermined target region in the game platform is less than an area threshold, determine that the position information of the at least one money substitute meets the preset alerting condition.

In some embodiments, the position information of the at least one money substitute includes a position of a center point of the at least one money substitute.

The second processing module 303 is further configured to: determine a target region where the center point is located in according to the position information of the at least one money substitute and the predetermined game platform image region division information; and in response to that the center point being located in a non-predetermined target region, determine that the position information of the at least one money substitute meets the preset alerting condition, the non-predetermined target region representing a region where the at least one money substitute is not allowed to be located in.

In some embodiments, the second processing module 303 is specifically configured to: under the condition that the position information and size information of the at least one money substitute are represented by a detection box for the at least one money substitute, mesh the detection box for the at least one money substitute, extract a preset number of feature points of the at least one money substitute from each divided mesh, and determine the target region where the at least one money substitute is located in according to a target region where each of the multiple feature points extracted from each divided mesh is located in.

In some embodiments, the detection result further includes attribute information of the at least one money substitute.

The second processing module 303 is further configured to: under the condition that the position information of the at least one money substitute does not meet the preset alerting condition, determine whether the attribute information of the at least one money substitute meets an attribute constraint corresponding to the target region where the at least one money substitute is located according to the game platform image; and under the condition that the attribute information of the at least one money substitute does not meet the attribute constraint corresponding to the target region where the money substitute is located in, generate second alert information.

In some embodiments, the attribute information includes at least one of a denomination, a type, an amount, or ownership information.

In some embodiments, the at least one frame of game platform image includes N frames of game platform images.

The first processing module 302 is specifically configured to: under the condition of determining N frames of game platform images each time using a sliding window, determine a detection result of each of the N frames of game platform images according to detection results of the N frames of game platform images in the sliding window, N being an integer greater than 1.

In some embodiments, the first processing module 302 is specifically configured to: determine attribute information of the same group of money substitutes in the detection results of the N frames of game platform images by target tracking; or, determine attribute information of each group of money substitutes of which a confidence is more than or equal to a confidence threshold in the detection results of the N frames of game platform images, and determine the attribute information of the same group of money substitutes by target tracking from the attribute information of each group of money substitutes of which the confidence is more than or equal to the confidence threshold; and determine the attribute information corresponding to a maximum occurrence frequency in an election manner from the attribute information of the same group of money substitutes, and determine a detection result of a target frame of image to be the attribute information corresponding to the maximum occurrence frequency, the target frame of image being any frame of image in the N frames of game platform images.

In practical applications, all of the acquisition module 301, the first processing module 302, and the second processing module 303 may be implemented using a processor in an electronic device. The processor may be at least one of an ASIC, a DSP, a DSPD, a PLD, an FPGA, a CPU, a controller, a microcontroller, or a microprocessor.

In addition, each function module in the embodiment may be integrated into a processing unit, each unit may also exist independently, and two or more than two units may also be integrated into a unit. The integrated unit may be implemented in a hardware form and may also be implemented in form of software function module.

When implemented in form of software function module and sold or used not as an independent product, the integrated unit may be stored in a computer-readable storage medium. Based on such an understanding, the technical solution of the embodiment substantially or parts making contributions to the conventional art or all or part of the technical solution may be embodied in form of software product, and the computer software product is stored in a storage medium, including a plurality of instructions configured to enable a computer device (which may be a personal computer, a server, a network device, etc.) or a processor to execute all or part of the steps of the method in the embodiment. The storage medium includes: various media capable of storing program codes such as a U disk, a mobile Hard Disk Drive (HDD), a Read Only Memory (ROM), a Random Access Memory (RAM), a magnetic disk or an optical disk.

Specifically, computer program instructions corresponding to the image processing method in the embodiments may be stored in a storage medium such as an optical disk, a hard disk and a U disk. When the computer program instruction corresponding to the image processing method in the storage medium is read or executed by an electronic device, any method for image processing of the abovementioned embodiments is implemented.

Based on the same technical concept of the abovementioned embodiments, referring to FIG. 4, an electronic device 4 provided in the embodiments of the disclosure is shown, which may include a memory 401 and a processor 402.

The memory 401 is configured to store computer programs and data.

The processor 402 is configured to execute the computer programs stored in the memory to implement any method for image processing of the abovementioned embodiments.

In practical applications, the memory 401 may be a volatile memory such as a RAM, or a non-volatile memory such as a ROM, a flash memory, an HDD or a Solid-State Drive (SSD), or a combination of the memories, and provides instructions and data for the processor 402.

The processor 402 may be at least one of an ASIC, a DSP, a DSPD, a PLD, an FPGA, a CPU, a controller, a microcontroller, or a microprocessor. It can be understood that, for different devices, other electronic components may be configured to realize functions of the processor, and no specific limits are made in the embodiment of the disclosure.

In some embodiments, a computer program product is provided. The computer program product comprises computer-executable instructions. When the computer-executable instructions run in a processor of a device, the processor implements any method for image processing of the abovementioned embodiments.

In some embodiments, functions or modules of the apparatus provided in the embodiment of the disclosure may be configured to execute the method described in the method embodiment and specific implementation thereof may refer to the descriptions about the method embodiment and, for simplicity, will not be elaborated herein.

The above descriptions about the embodiments focus on differences between each embodiment and the same or similar parts may refer to each other and will not be elaborated herein for simplicity.

The methods disclosed in each method embodiment provided in the application may be freely combined without conflicts to obtain new method embodiments.

The characteristics disclosed in each product embodiment provided in the application may be freely combined without conflicts to obtain new product embodiments.

The characteristics disclosed in each method or device embodiment provided in the application may be freely combined without conflicts to obtain new method embodiments or device embodiments.

From the above descriptions about the implementation modes, those skilled in the art may clearly know that the method of the abovementioned embodiments may be implemented in a manner of combining software and a necessary universal hardware platform, and of course, may also be implemented through hardware, but the former is a preferred implementation mode under many circumstances. Based on such an understanding, the technical solutions of the disclosure substantially or parts making contributions to the conventional art may be embodied in form of software product, and the computer software product is stored in a storage medium (for example, a ROM/RAM, a magnetic disk and an optical disk), including a plurality of instructions configured to enable a terminal (which may be a personal computer, a server, an air conditioner, a network device, etc.) to execute the method in each embodiment of the disclosure.

The embodiments of the disclosure are described above in combination with the drawings, but the disclosure is not limited to the abovementioned specific implementation modes. The abovementioned specific implementation modes are not restrictive but only schematic, those of ordinary skill in the art may be inspired by the disclosure to implement many forms without departing from the purpose of the disclosure and the scope of protection of the claims, and all these shall fall within the scope of protection of the disclosure.

1. A method for image processing, comprising:
acquiring at least one frame of game platform image;
detecting the at least one frame of game platform image to obtain a detection result of each of the at least one frame of game platform image, the detection result at least comprising position information of at least one money substitute; and
under a condition that the position information of the at least one money substitute meets a preset alerting condition, generating first alert information.

2. The method of claim 1, further comprising:
determining a target region where the at least one money substitute is located in according to the position information of the at least one money substitute and predetermined game platform image region division information, the predetermined game platform image region division information comprising position information of multiple target regions obtained by performing region division on a game platform; and
determining whether the position information of the at least one money substitute meets the preset alerting condition according to the target region where the at least one money substitute is located in.

3. The method of claim 2, wherein determining whether the position information of the at least one money substitute meets the preset alerting condition according to the target region where the at least one money substitute is located in comprises:
under a condition of determining that the at least one money substitute is located in at least two target regions, determining that the position information of the at least one money substitute meets the preset alerting condition.

4. The method of claim 2, wherein determining whether the position information of the at least one money substitute meets the preset alerting condition according to the target region where the at least one money substitute is located in comprises:
under a condition of determining that the at least one money substitute is located in at least two predetermined target regions, determining that the position information of the at least one money substitute meets the preset alerting condition, the predetermined target region comprising a region, where the at least one money substitute is allowed to be located in, in the target region.

5. The method of claim 2, wherein determining whether the position information of the at least one money substitute meets the preset alerting condition according to the target region where the at least one money substitute is located in comprises:
determining an area of a part of the at least one money substitute located within each predetermined target region in the game platform according to the position information of the at least one money substitute and the predetermined game platform image region division information, the predetermined target region representing a target region where money substitute is allowed to be located in; and
in response to the area of the part of the at least one money substitute located within each predetermined target region in the game platform being less than an area threshold, determining that the position information of the at least one money substitute meets the preset alerting condition.

6. The method of claim 2, wherein the position information of the at least one money substitute comprises a position of a center point of the at least one money substitute; and
the method further comprises:
determining a target region where the center point is located in according to the position information of the at least one money substitute and the predetermined game platform image region division information, and
in response to the center point being located in a non-predetermined target region, determining that the position information of the at least one money substitute meets the preset alerting condition, the non-predetermined target region representing a region where money substitute is not allowed to be located in.

7. The method of claim 2, wherein determining the target region where the at least one money substitute is located in according to the position information of the at least one money substitute and the predetermined game platform image region division information comprises:
under a condition that the position information and size information of the at least one money substitute are represented by a detection box for the at least one money substitute, meshing the detection box for the at least one money substitute;
extracting a preset number of feature points of the at least one money substitute from each divided mesh; and
determining the target region where the at least one money substitute is located in according to a target region where each of the feature points extracted from each divided mesh is located in.

8. The method of claim 1, wherein the detection result further comprises attribute information of the at least one money substitute; and
the method further comprises: under a condition that the position information of the at least one money substitute does not meet the preset alerting condition, determining whether the attribute information of the at least one money substitute meets an attribute constraint corresponding to a target region where the at least one money substitute is located in according to the game platform image, and
under a condition that the attribute information of the at least one money substitute does not meet the attribute constraint corresponding to the target region where the at least one money substitute is located in, generating second alert information.

9. The method of claim 8, wherein the attribute information comprises at least one of a denomination, a type, an amount, or ownership information.

10. The method of claim 1, wherein the at least one frame of game platform image comprises N frames of game platform images; and
detecting the at least one frame of game platform image to obtain the detection result of each of the at least one frame of game platform image comprises:
under a condition of determining the N frames of game platform images each time using a sliding window, determining a detection result of each of the N frames of game platform images according to detection results of the N frames of game platform images in the sliding window, N being an integer greater than 1.

11. The method of claim 10, wherein determining the detection result of each of the N frames of game platform images according to the detection results of the N frames of game platform images in the sliding window comprises:
determining attribute information of a same group of money substitutes in the detection results of the N frames of game platform images by target tracking; or, determining attribute information of each group of money substitutes of which a confidence is more than or equal to a confidence threshold in the detection results of the N frames of game platform images, and determining the attribute information of a same group of money substitutes by target tracking from the attribute information of each group of money substitutes of which the confidence is more than or equal to the confidence threshold; and
determining the attribute information corresponding to a maximum occurrence frequency in an election manner from the attribute information of the same group of money substitutes, and determining a detection result of a target frame of image to be the attribute information corresponding to the maximum occurrence frequency, the target frame of image being any frame of image in the N frames of game platform images.

12. An electronic device, comprising a processor and a memory configured to store computer programs capable of running in the processor, wherein when the processor runs the computer programs, the processor is configured to:
acquire at least one frame of game platform image;
detect the at least one frame of game platform image to obtain a detection result of each of the at least one frame of game platform image, the detection result at least comprising position information of at least one money substitute; and
under a condition that the position information of the at least one money substitute meets a preset alerting condition, generate first alert information.

13. The electronic device of claim 12, wherein the processor is further configured to:
determine a target region where the at least one money substitute is located in according to the position information of the at least one money substitute and predetermined game platform image region division information, the predetermined game platform image region division information comprising position information of multiple target regions obtained by performing region division on a game platform; and
determine whether the position information of the at least one money substitute meets the preset alerting condition according to the target region where the at least one money substitute is located in.

14. The electronic device of claim 13, wherein the processor is specifically configured to:
under a condition of determining that the at least one money substitute is located in at least two target regions, determine that the position information of the at least one money substitute meets the preset alerting condition.

15. The electronic device of claim 13, wherein the processor is specifically configured to:
under a condition of determining that the at least one money substitute is located in at least two predetermined target regions, determine that the position information of the at least one money substitute meets the preset alerting condition, the predetermined target region comprising a region, where the at least one money substitute is allowed to be located in, in the target region.

16. The electronic device of claim 13, wherein the processor is specifically configured to:
determine an area of a part of the at least one money substitute located within each predetermined target region in the game platform according to the position information of the at least one money substitute and the predetermined game platform image region division information, the predetermined target region representing a target region where the at least one money substitute is allowed to be located in; and
in response to the area of the part of the at least one money substitute located within each predetermined target region in the game platform being less than an area threshold, determine that the position information of the at least one money substitute meets the preset alerting condition.

17. The electronic device of claim 13, wherein the position information of the at least one money substitute comprises a position of a center point of the at least one money substitute; and
the processor is further configured to:
determine a target region where the center point is located in according to the position information of the at least one money substitute and the predetermined game platform image region division information, and
in response to the center point being located in a non-predetermined target region, determine that the position information of the at least one money substitute meets the preset alerting condition, the non-predetermined target region representing a region where the at least one money substitute is not allowed to be located in.

18. The electronic device of claim 13, wherein the processor is specifically configured to:
under a condition that the position information and size information of the at least one money substitute are represented by a detection box for the at least one money substitute, mesh the detection box for the at least one money substitute;
extract multiple feature points of the at least one money substitute from each divided mesh; and
determine the target region where the at least one money substitute is located in according to a target region where each of the multiple feature points extracted from each divided mesh is located in.

19. The electronic device of claim 12, wherein the detection result further comprises attribute information of the at least one money substitute; and
the processor is specifically configured to: under a condition that the position information of the at least one money substitute does not meet the preset alerting condition, determine whether the attribute information of the at least one money substitute meets an attribute constraint corresponding to a target region where the at least one money substitute is located in according to the game platform image, and
under a condition that the attribute information of the at least one money substitute does not meet the attribute constraint corresponding to the target region where the at least one money substitute is located in, generate second alert information.

20. A computer storage medium having stored therein computer programs which are executed by a processor to perform:
acquiring at least one frame of game platform image;
detecting the at least one frame of game platform image to obtain a detection result of each of the at least one frame of game platform image, the detection result at least comprising position information of at least one money substitute; and
under a condition that the position information of the at least one money substitute meets a preset alerting condition, generating first alert information.
